(19) United States
(12) Patent Application Publication
(10) Pub. No.: US 2014/0095238 A1
(43) Pub. Date: Apr. 3, 2014

(54) SUPPLY CHAIN FINANCIAL ORCHESTRATION SYSTEM WITH SEQUENCERS FOR EVENT-BASED ORCHESTRATION

(71) Applicant: Oracle International Corporation, Redwood Shores, CA (US)

(72) Inventors: Kalyana Chakravarthy DANDE, Hyderabad (IN); Balaji DUVARAGAMANI, Hyderabad (IN); Girish JHA, Hyderabad (IN); Nitish DAVE, Bilaspur (IN)

(73) Assignee: Oracle International Corporation, Redwood Shores, CA (US)

(21) Appl. No.: 14/036,063

(22) Filed: Sep. 25, 2013

Related U.S. Application Data
(60) Provisional application No. 61/707,630, filed on Sep. 28, 2012.

(51) Int. Cl. G06Q 10/06

(52) U.S. Cl. CPC G06Q 10/063114
USPC 705/7.15

(57) ABSTRACT

A system is provided that orchestrates tasks for a supply chain financial orchestration flow. The system selects tasks to be executed for an event. The system further creates a task group that includes the tasks. The system further assigns a task sequence identifier for each task, where there is a gap between two task sequence identifiers. The system further initiates an execution of a task of the plurality of tasks where the task is eligible for execution. The system further submits a task completion acknowledgement when the execution of the task is complete, where the task completion acknowledgement makes a subsequent task eligible for execution. The system further receives a plurality of events that includes the event, creates an event group that includes the plurality of events, assigns an event sequence identifier for each event of the plurality of events, where there is a gap between two event sequence identifiers, and submits an event completion acknowledgement when the execution of the plurality of tasks for the event is complete.

### CROSS-REFERENCE TO RELATED APPLICATIONS

This application claims priority of U.S. Provisional Patent Application Ser. No. 61/707,630, filed on Sep. 28, 2012, the subject matter of which is hereby incorporated by reference.

### FIELD

One embodiment is directed to a computer system, and more particularly, to a computer system that orchestrates supply chain financial processes.

### BACKGROUND

Large multi-national companies, or other enterprises, often operate through a number of subsidiary companies, or other legal entities, spread across the globe. These subsidiary companies can be further divided into business units or lines of businesses. The intersection of each subsidiary company and line of business (identified as a “profit center business unit”) can become a supply chain entity that engages in manufacturing, purchase, and/or sale of goods and services.

The profit center business units typically engage commercially with an external supply chain, such as a collection of suppliers and customers. They can also engage in internal trades, or internal transfers, within the subsidiary company. One example type of an internal trade is an “inter-company trade,” where a profit center business unit belonging to one subsidiary company trades with a profit center business unit belonging to another subsidiary company, at arm's length terms and conditions. Another example type of an internal trade is an “intra-company trade,” where two profit center business units belonging to the same subsidiary company trade among each other on a competitive basis. Such internal trades can trigger internal transactions pre-defined as part of internal trade relationship. Further, such internal trades can trigger one or more tasks to be executed. The tasks to be executed should follow a sequence setup in these trade relationships.

### SUMMARY

One embodiment is a system that orchestrates tasks for a supply chain financial orchestration flow. The system selects tasks to be executed for an event. The system further creates a task group that includes the tasks. The system further assigns a task sequence identifier for each task, where there is a gap between two task sequence identifiers. The system further initiates an execution of a task of the plurality of tasks where the task is eligible for execution. The system further submits a task completion acknowledgement when the execution of the task is complete, where the task completion acknowledgement makes a subsequent task eligible for execution.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates an example supply chain financial orchestration flow, according to an embodiment of the invention.

FIG. 3 illustrates a block diagram of an example architecture of a supply chain financial orchestration system, according to an embodiment of the invention.

FIG. 4 illustrates a block diagram of an event triggering an execution of tasks, according to an embodiment of the invention.

FIG. 5 illustrates a block diagram of tasks that are submitted to a task group with a sequence identifier, according to an embodiment of the invention.

FIG. 6 illustrates a flow diagram of the task sequencer functionality of a supply chain financial orchestration sequencer module, according to an embodiment of the invention.

FIG. 7 illustrates a block diagram of a sequence of occurrence of events and their occurrence timings, according to an embodiment of the invention.

FIG. 8 includes a block diagram of an event group that includes events and event completion acknowledgments, according to an embodiment of the invention.

FIG. 9 illustrates a flow diagram of the event sequencer functionality of a supply chain financial orchestration sequencer module, according to another embodiment of the invention.

FIG. 10 illustrates a block diagram of a repetitive event occurrence hierarchy and the events' occurrence timings, according to an embodiment of the invention.

FIG. 11 illustrates a block diagram of event groups that include events and event completion acknowledgments, according to an embodiment of the invention.

FIG. 12 illustrates a flow diagram of the repetitive event sequencer functionality of a supply chain financial orchestration sequencer module, according to another embodiment of the invention.

### DETAILED DESCRIPTION

According to an embodiment, a supply chain financial orchestration system is provided that can act as an event-based orchestration system. For each event received by the supply chain financial orchestration system, the supply chain financial orchestration system can initiate one or more tasks for execution. The tasks that are to be executed can be grouped and sequenced by the supply chain financial orchestration system. Further, the supply chain financial orchestration system can sequence the tasks so that a task can only be initiated when its predecessor task has completed execution, and the supply chain financial orchestration system has received a task completion acknowledgement indicating that the predecessor task has completed execution. This can be accomplished by assigning task sequence identifiers to the tasks, where there is a gap between a task sequence identifier for a predecessor task and a task sequence identifier for a successor task, if the predecessor task has not completed execution. The supply chain financial orchestration system can further sequence events so that tasks related to an event are not initiated for execution until all tasks related to a predecessor event have completed execution. This can be accomplished by assigning event sequence identifiers to the events, where there is a gap between an event sequence identifier for a predecessor event and an event sequence identifier for a successor event, if the tasks for the predecessor event have not completed execution. The supply chain financial orchestration system can further process multiple child events for a specific parent event by creating multiple event groups and assigning the multiple child events into different event groups.

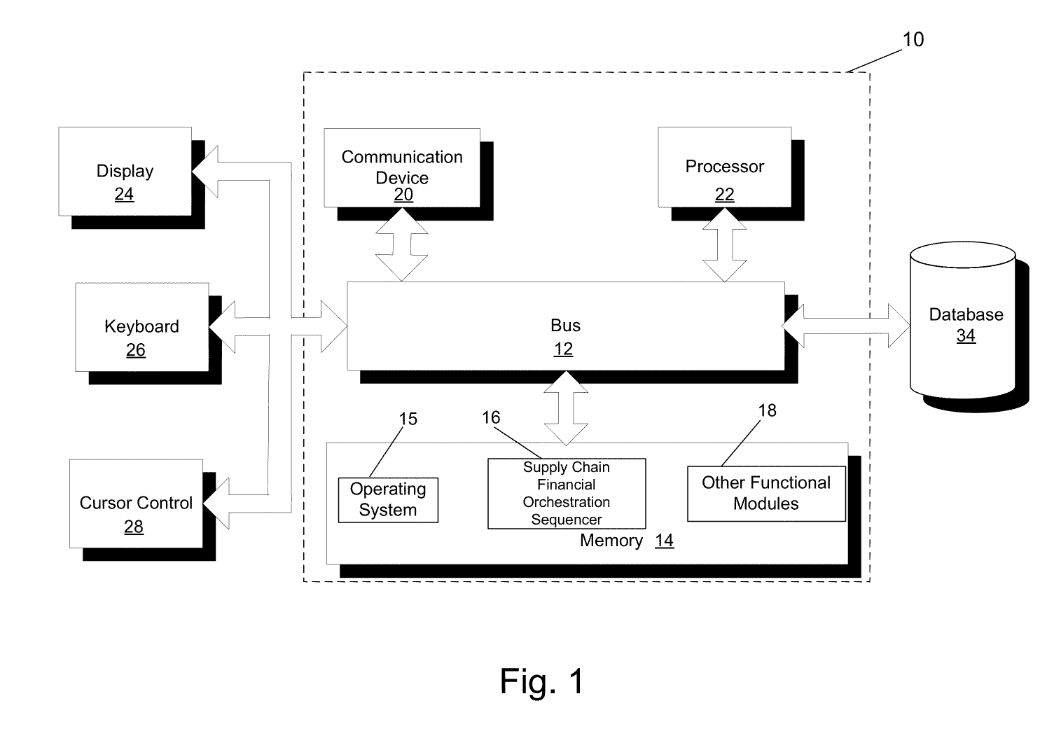

FIG. 1 illustrates a block diagram of a supply chain financial orchestration system 10 that may implement one embodiment of the invention. Supply chain financial orchestration system 10 includes a bus 12 or other communications mechanism for communicating information between components of supply chain financial orchestration system 10. Supply chain financial orchestration system 10 also includes a processor 22, operatively coupled to bus 12, for processing information and executing instructions or operations. Processor 22 may be any type of general or specific purpose processor. Supply chain financial orchestration system 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. Supply chain financial orchestration system 10 further includes a communication device 20, such as a network interface card or other communications interface, to provide access to a network. As a result, a user may interface with supply chain financial orchestration system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with supply chain financial orchestration system 10.

According to one embodiment, memory 14 can store software modules that may provide functionality when executed by processor 22. The modules can include an operating system 15, a supply chain financial orchestration sequencer module 16, as well as other functional modules 18. Operating system 15 can provide an operating system functionality for supply chain financial orchestration system 10. Supply chain financial orchestration sequencer module 16 can provide functionality for sequencing a plurality of tasks for a plurality of events, as is described in more detail below. In certain embodiments, supply chain financial orchestration sequencer module 16 can comprise a plurality of modules that each provide specific individual functionality for sequencing a plurality of tasks for a plurality of events. Supply chain financial orchestration system 10 can also be part of a larger system. Thus, supply chain financial orchestration system 10 can include one or more additional functional modules 18 to include the additional functionality. For example, functional modules 18 may include modules that provide additional functionality, such as an “Oracle Fusion Applications” product from Oracle Corporation. In another example, functional modules 18 may include enterprise resource planning (“ERP”) modules of an ERP system, where an ERP system is a computer system that integrates several data sources and processes of an organization into a unified system.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

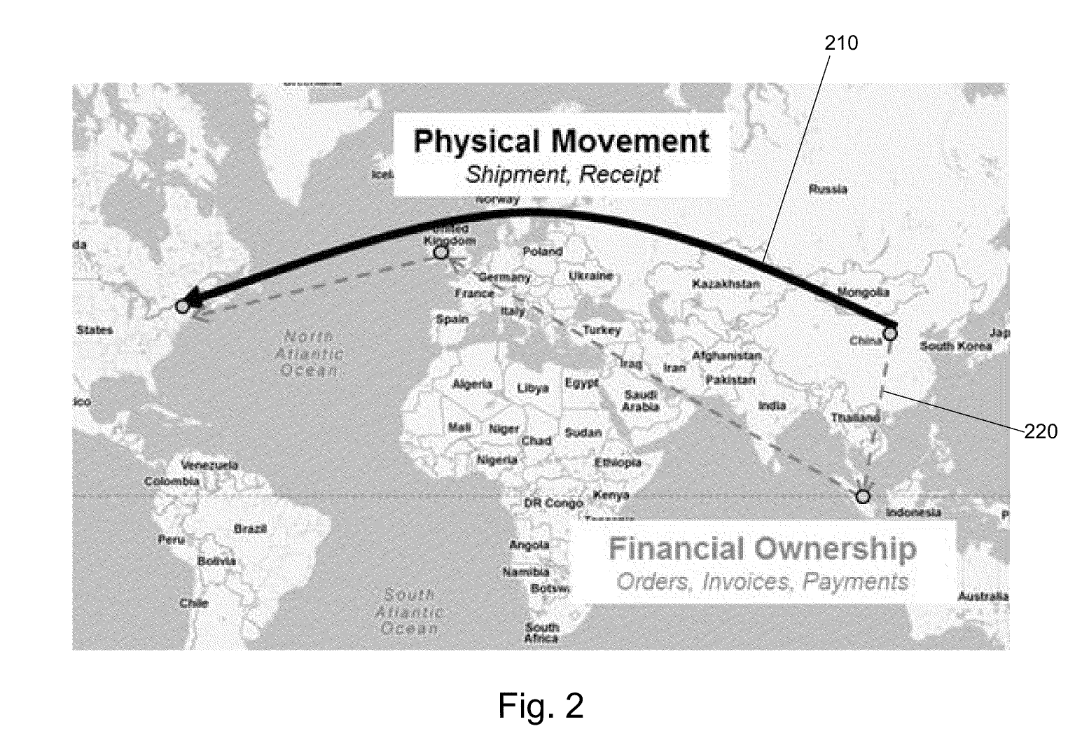

FIG. 2 illustrates an example supply chain financial orchestration flow, according to an embodiment of the invention. The supply chain financial orchestration flow is between a shipping entity in China and a receiving entity in the United States. As illustrated in FIG. 2, the supply chain financial orchestration flow includes a physical movement flow 210 and a financial flow 220. Physical movement flow 210 represents the physical movement of items from the shipping entity in China, to the receiving entity in the United States, and can involve the physical movement through one or more intermediate entities. Physical movement flow 210 can include one or more physical transactions that are executed in association with the physical movement of the items (such as shipments, receipts, etc.). Financial flow 220 represents the change in financial ownership of items from the shipping entity in China, to the receiving entity in the United States, and can involve the change in financial ownership of one or more intermediate entities. Financial flow 220 can include one or more financial transactions that are executed in associate with the change in financial ownership of the items (such as orders, invoices, payments, etc.). As illustrated in FIG. 2, a physical movement flow can be separate and independent of a financial flow within a supply chain financial orchestration system.

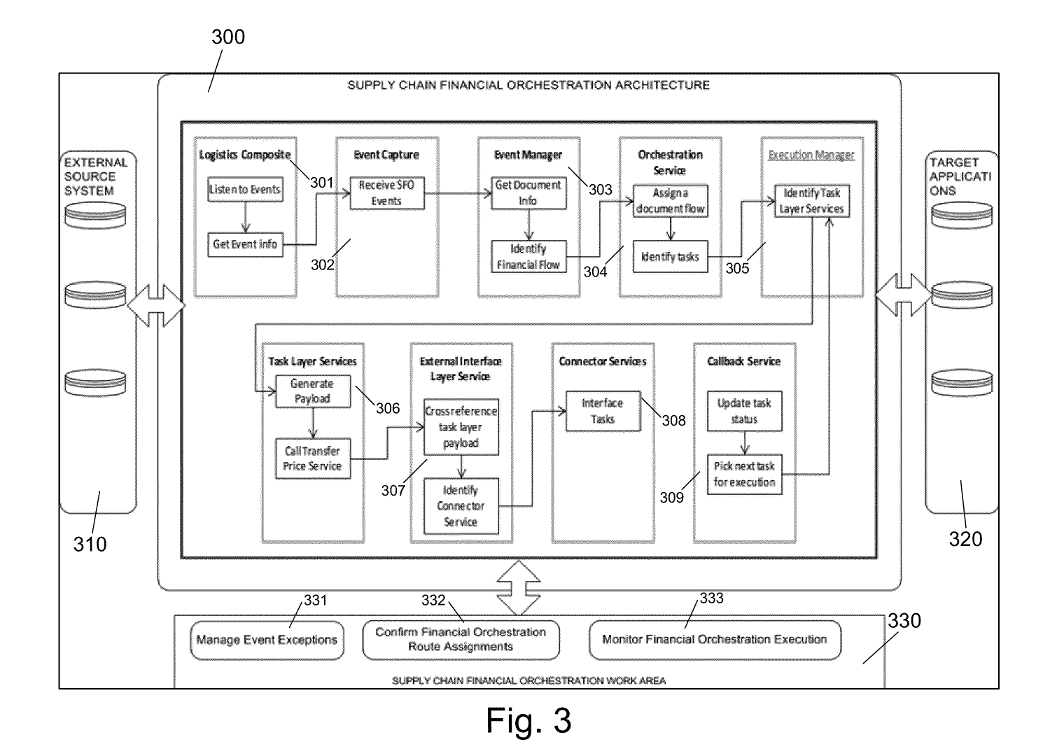

FIG. 3 illustrates a block diagram of an example architecture of a supply chain financial orchestration system 300, according to an embodiment of the invention. According to the embodiment, supply chain financial orchestration system 300 is a configurable system that manages internal trade relationships between entities belonging to an enterprise, where the enterprise is typically spread across geographies. Supply chain financial orchestration system 300 can define a nature of trade relationships, business rules, internal controls, regulatory compliances, and other terms and conditions required to execute, monitor, and evaluate trade transactions emanating out of such relationships. More specifically, supply chain financial orchestration system 300 can listen to events that occur in supply chain transactions in various external source systems, and can identify internal transactions (such as inter-company transactions and intra-company transactions) based on pre-defined trade relationships. Once the internal transactions are identified, supply chain financial orchestration system 300 can create necessary accounting and documentations required to be generated for the internal transactions according to the business rules defined in supply chain financial orchestration system 300.

According to the illustrated embodiment, supply chain financial orchestration system 300 includes event mediator 301, event capture 302, event manager 303, orchestration service 304, execution manager 305, task layer service 306, external interface layer service 307, connector service 308, and callback service 309. Event mediator 301 listens for events generated by an external source system (i.e., application) of external source systems (i.e., applications) 310. If an event is of interest to supply chain financial orchestration system 300, event mediator 301 can also call a web service exposed by the external source system of external source systems 310 to enrich the event details. Event mediator 301 then sends the event to event capture 302. Event capture 302 validates the event details retrieved after enrichment, and stores the event in an external source system format.

Subsequently, event manager 303 identifies a source document enrichment web service based on a source order type, and calls the source document enrichment web service for enrichment. The source document enrichment service is exposed by an external source system of external source systems 310 where the source order originated. Event manager 303 can pass a source document identifier as an input parameter to the enrichment web service and can retrieve the source document information, where a source document identifier is a unique identifier of the source document that is communicated to the external source system of external source systems 310. The external source system of external source systems 310 that is responsible for capturing the physical transaction can be responsible for passing the source document identifier as part of event information. Supply chain financial orchestration system 300 can maintain an association between a supply chain event and a source document type. Event manager 303 can further transform the source document information into a format that is understandable by supply chain financial orchestration system 300, and can identify a supply chain financial orchestration flow based on qualifiers, source document type, physical route, parties involved in an internal trade, and a priority of the supply chain financial orchestration flow. Further, a supply chain financial orchestration flow can be date effective. This means that any modification to a supply chain financial orchestration flow can cause a new effective date to be associated with the supply chain financial orchestration flow. Thus, transactions pertaining to a source document created before the effective date of the modification can be associated with the original supply chain financial orchestration flow, and transactions pertaining to a source document created after the effective date of the modification can be associated with the modified supply chain financial orchestration flow.

Orchestration service 304 verifies whether a supply chain financial orchestration flow is already assigned to a source document or not. If the supply chain financial orchestration flow is not already assigned, orchestration service 304 can assign the supply chain financial orchestration flow to the source document, and can generate the tasks that are to be performed between internal entities based on the documentation and accounting rules setup for the supply chain financial orchestration flow (such as a global procurement flow, a customer shipment flow, and an internal transfer flow). A global procurement flow is a supply chain financial orchestration flow where a central buying entity buys goods from suppliers on behalf of one or more internal entities. The supplier liability is borne by the purchasing entity. The purchasing and requesting entity settle the transaction among themselves using a transfer price (sometimes through one or more intermediary entities). A customer shipment flow is a supply chain financial orchestration flow in which a selling business unit is different from a profit center business unit of the entity that owns and ships the goods. The selling entity receives an order from a customer, and the shipping entity ships the goods directly to the customer. The shipping entity is settled financially by the selling entity (sometimes through one or more intermediary entities). A customer shipment flow can be an internal drop shipment flow, which is a forward customer shipment flow, or a customer drop shipment flow, or a return customer shipment flow. An internal transfer flow is a supply chain financial orchestration flow in which physical movement of goods happens between internal entities. The internal entities settle the financial transactions among themselves using a transfer price.

The tasks that are to be performed can be specific to a forward flow and a return flow for the supply chain financial orchestration flow. A forward flow is a flow of events that proceeds in a specific direction (such as from a supplier entity to a purchaser entity), and a return flow is a flow of events that proceeds in a reverse direction (such as from a purchaser entity to a supplier entity). In addition to ownership transfer between internal entities, events indicating ownership transfer from a supplier entity to a purchasing entity can also be setup in a supply chain financial orchestration flow definition. When an event designated as a supplier ownership change event occurs, orchestration service 304 can generate the tasks for creating trade distributions to book supplier accrual and costs in a costing system, as well. Execution manager 305 invokes a task layer service based on a task type. Generally, the tasks are performed in a defined sequence, and if there is any dependency from a previous task, execution manager 305 can wait for the previous task to complete. Example task types can include inter-company trade documents (e.g., purchase order and sales order), trade distribution tasks related to costing, inter-company receivable invoices related to inter-company receivable, payables invoice, or credit memo tasks that are set in documentation and accounting rules. Task types can also include user-defined tasks.

Task layer service 306 creates a task layer service payload. Task layer service 306 can include logic to populate the payload data depending on a global procurement flow, a customer shipment flow, or an internal transfer flow. Task layer service 306 can also call a transfer price service to get a transfer price, where the transfer price is a price in which a selling entity sells goods to a purchasing entity, where the selling entity and the purchasing entity are involved in an internal trade. External interface layer service 307 identifies a target system (i.e., application) of target systems (i.e., applications) 320, and obtains a connector service (e.g., connector service 308) for the target system of target systems 320 based on the task type. Connector service 308 transforms the task layer service payload into a format which is understandable by the target system of target systems 320. Once the task data is transformed according to a target system format, connector service 308 calls a web service to interface tasks in interface tables of the target system of target systems 320. Callback service 309 receives responses from the target system of target systems 320 and updates the task status. If the task is a last task in a sequence, then the supply chain financial orchestration is complete. Otherwise, the next task in the sequence is selected, and execution manager 305 is invoked with the task type.

Supply chain financial orchestration system 300 further includes a supply chain financial orchestration work area 330 that includes a plurality of user interfaces that allow a user to interact with supply chain financial orchestration system 300. Supply chain financial orchestration work area 330 includes manage event exceptions 331, confirm financial orchestration route assignments 332, and monitor financial orchestration execution 333. Manage event exceptions 331 is a user interface that allows users to view, troubleshoot, and manage events which faulted due to a setup or technical reason. Confirm financial orchestration route assignments 332 is a user interface that allows a user to confirm a supply chain financial orchestration flow before the tasks of the supply chain financial orchestration flow are initiated by orchestration service 304. Monitor financial orchestration execution 333 is a user interface that allows user to monitor supply chain financial orchestration flows that are in progress, that have not started, and that have completed.

As previously described, a supply chain financial orchestration system can be an event-based orchestration system. This means that, for each event received by the supply chain financial orchestration system, a dynamic set of tasks can be initiated for execution. The events can represent internal transactions, and the tasks can be pre-defined as part of internal trade relationships. The tasks to be executed can be required to follow a sequence setup in the trade relationships. Thus, a given task can be prohibited from being executed unless its predecessor task has completed its execution. As the set of tasks is dynamic, and the sequence of their execution can be guaranteed, the supply chain financial orchestration system can include a mechanism for queuing these tasks.

According to an embodiment, a mediator resequencer can be used to queue the tasks. A resequencer is a system component that can rearrange a stream of related but out-of-sequence messages into a sequential order. When incoming messages arrive at a resequencer, they may be in a random order. The resequencer can order the messages based on sequential or chronological information. The resequencer can further send the messages to one or more external target services in an orderly manner. In accordance with the embodiment, the resequencer can work with two central concepts: groups and sequence identifiers. A sequence identifier is an identifying part of a message, and messages can be rearranged based on the sequence identifier. Messages arriving for resequencing can be split into groups, and the messages within a group can be sequenced according to the sequence identifier. Sequencing of messages within a group can be independent of the sequencing of messages in any other group. Thus, groups are not dependent on each other, and can be processed independently of each other. Examples of groups include task groups, which include one or more tasks and each task is associated with a task sequence identifier, and event groups, which include one or more events and each event is associated with an event sequence identifier.

The tasks that are initiated for execution by the supply chain financial orchestration system for a given event can be grouped and sequenced by a mediator resequencer. The default behavior of the mediator resequencer can be that the mediator resequencer does not wait for a predecessor task to complete its execution before the mediator resequencer initiates execution of a successor task. For example, if tasks T1, T2, and T3 are the tasks that are to be initiated for execution, and if the tasks are submitted to the mediator resequencer with sequence identifiers of 1, 2, 3, then tasks T1, T2, and T3 are all submitted for execution together. This default behavior can be a limitation for the supply chain financial orchestration system, as it may be required to have task T2 wait for the completion of task T1, and it may be required to have task T3 wait for the completion of task T2. Thus, according to an embodiment, a mediator resequencer can create a task group and assign tasks to the task group with a gap of sequence identifiers between the tasks. In accordance with this embodiment, the mediator resequencer can be identified as a task sequencer within a supply chain financial orchestration system. Thus, in the aforementioned example, tasks T1, T2, and T3 can be submitted to a task sequencer (i.e., a mediator resequencer) with task sequence identifiers of 1, 3, and 5, respectively. Upon completion of task T1, the supply chain financial orchestration system can send a task completion acknowledgment for task T1 as a task to the task group created by the mediator resequencer with a task sequence identifier of 2. Since the task group now includes a task with a task sequence identifier of 2, the tasks with task sequence identifiers of 2 and 3 (which includes task T2) are submitted for execution. Similarly, when task T2 completes its execution, the supply chain financial orchestration system can send a task completion acknowledgment for task T2 as a task with a task sequence identifier of 4, and the tasks with task sequence identifiers 4 and 5 (which includes task T3) are submitted for execution.

According to an embodiment, a task sequencer (i.e., mediator resequencer) can be a component of an execution manager (such as execution manager 305 of FIG. 3). An orchestration service (such as orchestration service 304 of FIG. 3) can identify a set of tasks to be performed for a received event, can create a task group in the task sequencer, and can assign task sequence identifiers to the tasks with a gap of 1 between the task sequence identifiers. A callback service (such as callback service 309) can update a status of the current task and when the status is “Success” (i.e., the current task has completed execution), the callback service can invoke the execution manager and inform the execution manager to submit the task completion acknowledgment to the task sequencer with a task sequence identifier of the current task+1. The task sequencer subsequently submits the next task for execution.

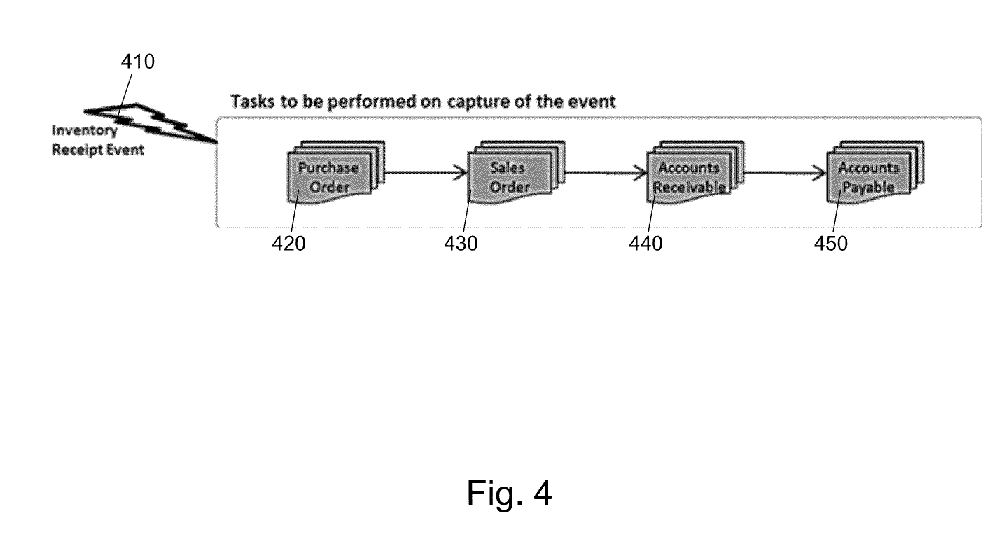

FIG. 4 illustrates a block diagram of an event triggering an execution of tasks, according to an embodiment of the invention. More specifically, an inventory receipt event 410 is received at a supply chain financial orchestration system. The receipt of inventory receipt event 410 triggers a creation of a purchase order invoice, a sales order invoice, an accounts receivable invoice, and an accounts payable invoice between two entities. Thus, the receipt of inventory receipt event causes the supply chain financial orchestration system to initiate an execution of a purchase order task 420, a sales order task 430, an accounts receivable task 440, and an accounts payable task 450.

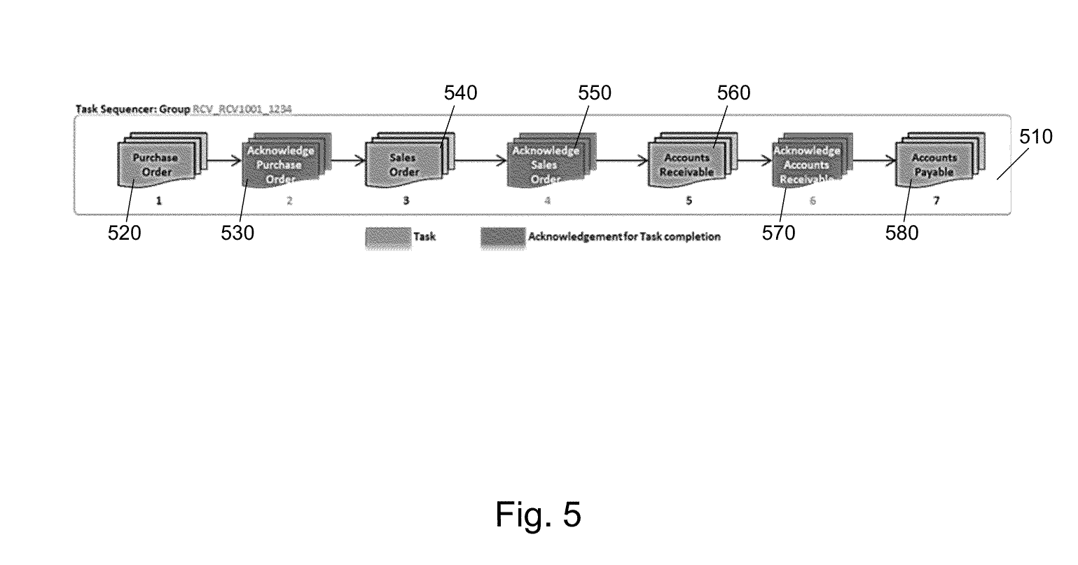

FIG. 5 illustrates a block diagram of tasks that are submitted to a task group with a sequence identifier, according to an embodiment of the invention. More specifically, a task group 510 is created within a task sequencer (i.e., a mediator resequencer). Task group 510 can be named using a format EventType_Event_ID_EventSystemID (e.g., RCV_RCV1001_1234). Further, a purchase order task 520, a sales order task 540, an accounts receivable task 560, and an accounts payable task 580, can be submitted to task group 510 within the task sequencer with a gap of 1 in their task sequence identifiers (e.g., 1, 3, 5, and 7, respectively). When execution of purchase order task 520 is complete, a purchase order task completion acknowledgment 530 can be submitted to task group 510 within the task sequencer with a task sequence identifier of 2, where the submission of purchase order task completion acknowledgment 530 can make the next task in task group 510 (i.e., sales order task 540) eligible for execution. When execution of sales order task 540 is complete, a sales order task complete acknowledgment 550 can be submitted to task group 510 with a task sequence identifier of 4, where the submission of sales order task completion acknowledgement 550 can make the next task in task group 510 (i.e., accounts receivable task 560) eligible for execution. When execution of accounts receivable task 560 is complete, an accounts receivable task completion acknowledgment 570 can be submitted to task group 510 with a task sequence identifier of 6, where the submission of accounts receivable task completion acknowledgement 570 can make the next task in task group 510 (i.e., accounts payable task 580) eligible for execution.

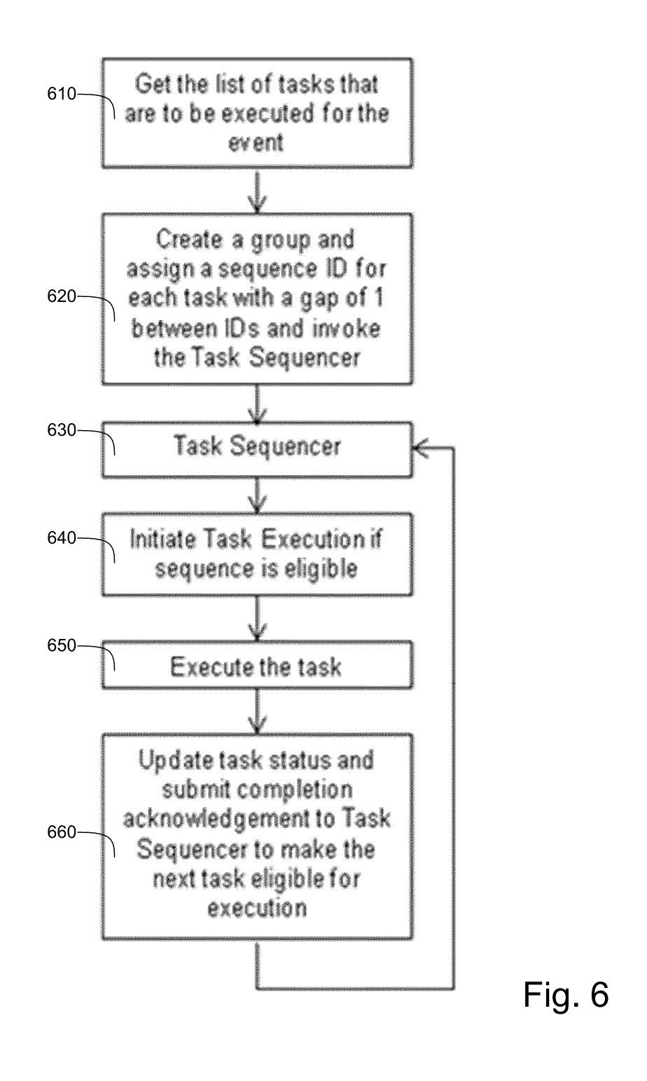

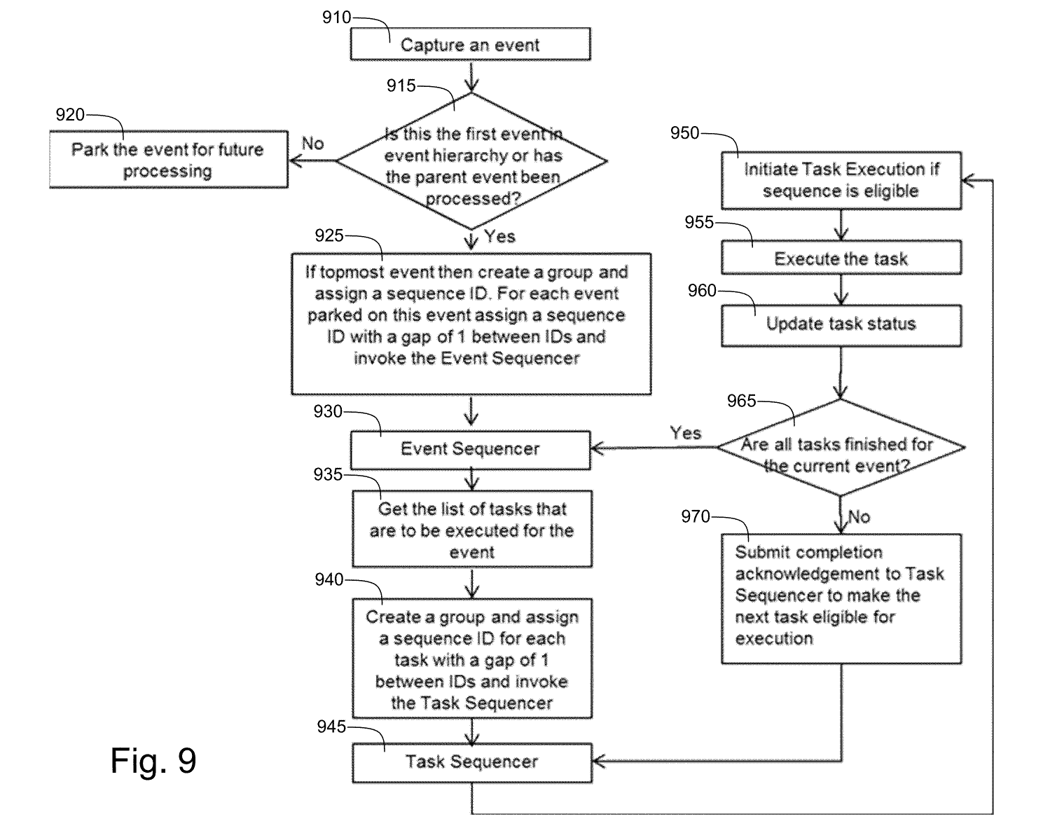

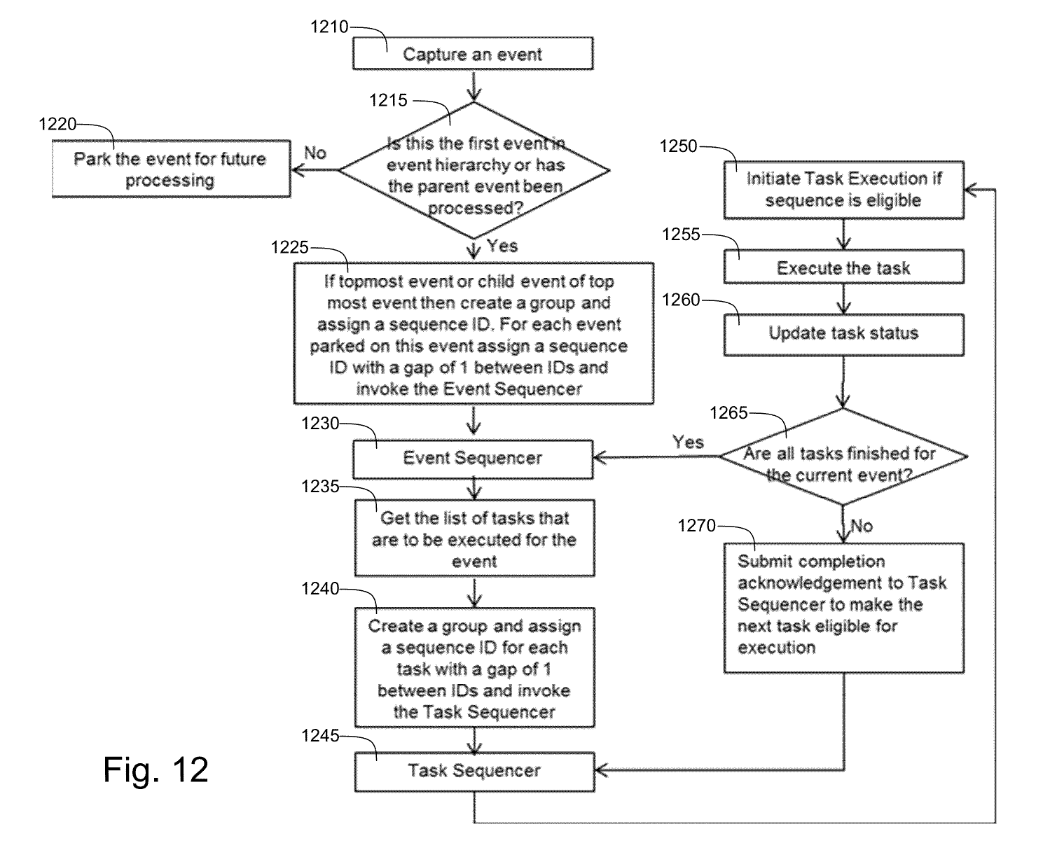

FIG. 6 illustrates a flow diagram of the task sequencer functionality of a supply chain financial orchestration sequencer module (such as supply chain financial orchestration sequencer module 16 of FIG. 1), according to an embodiment of the invention. In one embodiment, the functionality of the flow diagram of FIG. 6, as well as the functionality of the flow diagram of FIG. 9 and the functionality of the flow diagram of FIG. 12, are each implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software.

The flow begins and proceeds to 610. At 610, a list of tasks that are to be executed for an event are selected. The tasks can be defined for a supply chain financial orchestration flow, where a supply chain financial orchestration flow defines a trade relationship between a first entity and a second entity. Each task can be a financial accounting task associated with an internal transaction. The event can also be defined as a task generating event for the supply chain financial orchestration flow. The flow then proceeds to 620.

At 620, a task group is created that includes the selected tasks. A task sequence identifier is assigned to each task of the task group, where there is a gap between two task sequence identifiers. In certain embodiments, each task sequence identifier can be a numeric value, and the gap between two task sequence identifiers can be a gap of one. In certain embodiments, there can be a gap between more than two task sequence identifiers. A task sequencer is subsequently invoked. A task sequencer can be a mediator resequencer, where a mediator resequencer is a system component that can rearrange a stream of related but out-of-sequence messages into a sequential order. The flow then proceeds to 630.

At 630, the task sequencer receives the task group that includes the selected tasks. The flow then proceeds to 640.

At 640, the task sequencer initiates an execution of a task of the selected tasks if the task is eligible for execution. The flow then proceeds to 650.

At 650, the task is executed. In certain embodiments, an external target system can execute the task. The flow then proceeds to 660.

At 660, a task status is updated. In certain embodiments, a callback service updates the task status. Also in certain embodiments, the task status is updated to a status that indicates the task has completed execution. If there are no more tasks of the selected tasks to be executed, the flow ends. However, if there are tasks of the selected tasks to be executed, a task completion acknowledgement is submitted to the task sequencer, where the task completion acknowledgment makes a subsequent task of the selected tasks eligible for execution, and the flow returns to 630. Subsequently, an execution of a subsequent task is initiated, and even further, an execution of each task of the selected tasks is ultimately initiated.

In one embodiment, a supply chain financial orchestration system can be required to honor a sequence of events in an order that is pre-defined by a user of the supply chain financial orchestration system. Since external source systems can be different, a time at which the external source systems raise the events can also be different. A mediator resequencer can be used to queue the events in a pre-defined order. An event group can be created, and the events can be sequenced so that tasks related to a successor event (e.g., event E2) are not initiated for execution until all the tasks related to a predecessor event (e.g., event E1) have completed execution. This allows the supply chain financial orchestration system to honor the sequence of the events (e.g., events E1 and E2) in the pre-defined order. If the successor event (e.g., event E2) is received before the predecessor event (e.g., event E1) is received, then the successor event (e.g., event E2) is parked for further processing. Once the predecessor event (e.g., event E1) is received, the supply chain financial orchestration system initiates execution of both events (e.g., events E1 and E2) using the mediator resequencer. In accordance with this embodiment, the mediator resequencer can be identified as an event sequencer within a supply chain financial orchestration system. An event group can be created in the event sequencer (i.e., mediator resequencer), when an event is captured (e.g., event E1) and any parked events (e.g., event E2) are selected and pushed to the event sequencer (i.e., mediator resequencer) with a gap between the two event sequence identifiers.

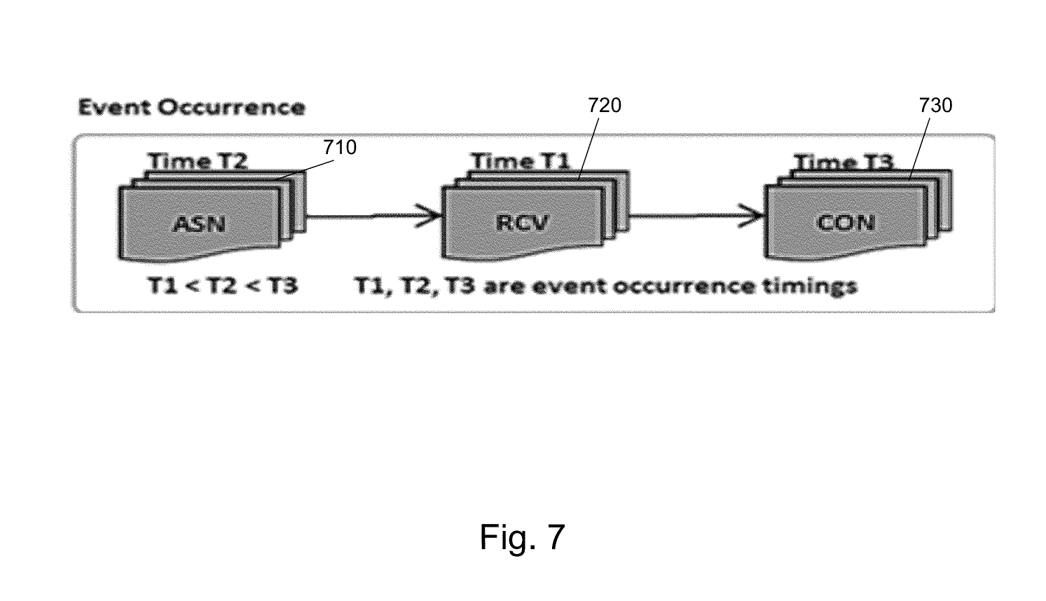

FIG. 7 illustrates a block diagram of a sequence of occurrence of events and their occurrence timings, according to an embodiment of the invention. According to the embodiment, an event hierarchy can be defined by a user, where an expected order of execution of events is as follows: first, an advanced shipment notice (“ASN”) event, and its related tasks, are executed; second, a receipt of goods (“RCV”) event, and its related tasks, are executed; and third, a consumption of goods (“CON”) event, and its related tasks, are executed. Thus, an ASN event is a parent event of an RCV event, the RCV event is the child event of the ASN event, the RCV event is a parent event of a CON event, and the CON event is a child event of the RCV event.

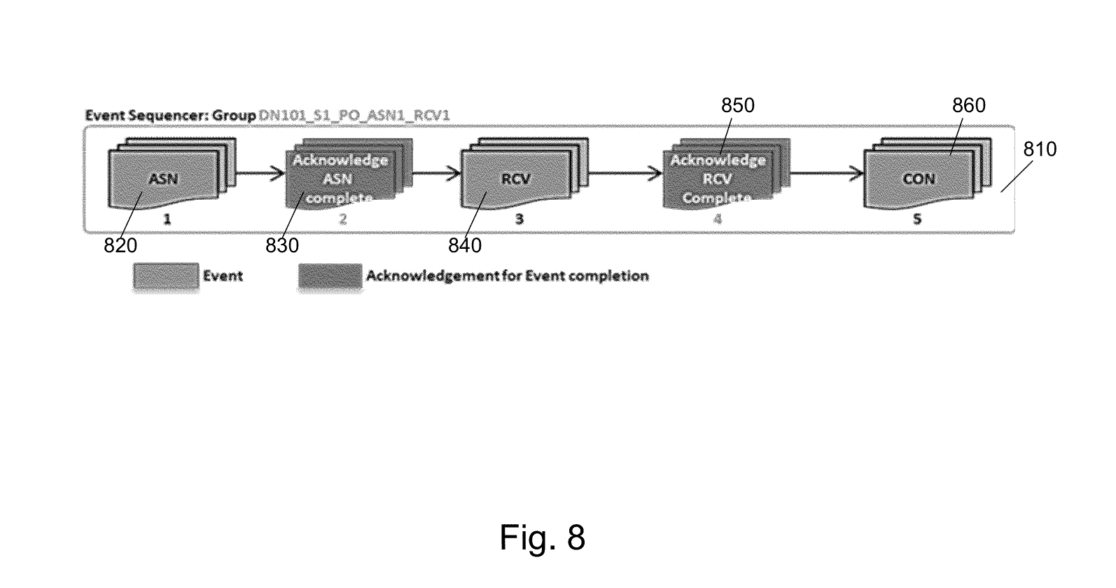

However, a supply chain financial orchestration system may not receive the events in the order defined by the event hierarchy. For example, as illustrated in FIG. 7, the supply chain orchestration system may receive event 720 (i.e., event RCV1) at time T1, may receive event 710 (i.e., event ASN1) at time T2, and may receive event 730 (i.e., event CON1) at time T3. Because event 720 is not eligible for execution at time T1 (due to the fact that event 710, event 720's parent event, has not yet been received by the supply chain financial orchestration system), event 720 is parked. This is further described in conjunction with FIG. 8.

FIG. 8 includes a block diagram of an event group that includes events and event completion acknowledgements, according to an embodiment of the invention. More specifically, an event group 810 is created within an event sequencer (i.e., a mediator resequencer). Event group 810 can be named using a format DocNum_SystemID_DocType_(EventType1+Occurrence)_(EventType2+Occurrence)_. . . _(EventType(n−1)+Occurrence) (e.g., DN101_S1_PO_ASN1_RCV1). As previously described in conjunction with FIG. 7, a supply chain orchestration system can receive event 840 (i.e., event RCV1) at time T1, may receive event 820 (i.e., event ASN1) at time T2, and may receive event 860 (i.e., event CON1) at time T3. Because event 840 is not eligible for execution at time T1 (due to the fact that event 820, event 840's parent event, has not yet been received by the supply chain financial orchestration system), event 840 is parked. When event 820 is received by the supply chain orchestration system, events 820 and 840 are pushed to event group 810, and event sequence identifiers of 1 and 3 are assigned to events 820 and 840, respectively. When event 860 is received by the supply chain financial orchestration system, then event 860 is pushed to event group 810 with the event sequence identifier of either 4 or 5 based on a status of completion of tasks related to event 840. More specifically, an event sequence identifier of 4 is assigned to event 860 when all the tasks related to event 840 have completed their execution. Otherwise, an event sequence identifier of 5 is assigned to event 860. This is illustrated in the following table:

| | Parent | | Event Sequence |
|---|---|---|---|
| Event | Event | Event Group Name | Identifier |
| ASN | | DN101_S1_PO_ASN1_RCV1 | 1 |
| RCV | ASN | DN101_S1_PO_ASN1_RCV1 | 3 |
| CON | RCV | DN101_S1_PO_ASN1_RCV1 | 4 or 5 |

According to the embodiment, event sequence identifiers are set with a gap of 1 so that the tasks related to successor event are not initiated for execution until the completion of all the tasks related to predecessor event. When all of the tasks related to an event have completed their execution, an event completion acknowledgment is sent to the event sequencer so that the tasks related to the next event can be submitted to a task sequencer for execution. In the illustrated embodiment, when all the tasks related to event 820 have completed their execution, an event completion acknowledgement 830 (i.e., ASN event completion acknowledgment) is submitted to the event sequencer, which pushes all the tasks related to event 840 to the task sequencer for execution. Similarly, when all the tasks related to event 840 have completed their execution, an event completion acknowledgment 850 (i.e., RCV event completion acknowledgement) is submitted to the event sequencer, which pushes all the tasks related to event 860 to the task sequencer for execution.

FIG. 9 illustrates a flow diagram of the event sequencer functionality of a supply chain financial orchestration sequencer module, according to another embodiment of the invention. The flow begins and proceeds to 910. At 910, an event is received. In certain embodiments, the event can be an event of a plurality of events. The flow then proceeds to 915.

At 915, it is determined whether the event is a first event in an event hierarchy or whether a parent event of the event has been processed. The event hierarchy can define an order of execution of the plurality of events. A predecessor event can be a parent event of a successor event within the event hierarchy. Further, the successor event can be a child event of the predecessor event within the event hierarchy. If it is determined that the event is not a first event in the event hierarchy, and that the parent event of the event has not been processed, the flow proceeds to 920. If it is determined that the event is a first event in the event hierarchy, or that the parent event of the event has been processed, the flow proceeds to 925.

At 920, the event is parked within an event sequencer for future processing. An event sequencer can be a mediator resequencer, where a mediator resequencer is a system component that can rearrange a stream of related but out-of-sequence messages into a sequential order. The flow then ends.

At 925, if the event is a topmost event of an event hierarchy (i.e., if the event is the first event received in the event hierarchy), then an event group is created that includes the plurality of events. An event sequence identifier is assigned to the event. If there are any events parked and waiting for the current event, then, for all the parked events and the current event, an event sequence identifier is assigned that includes a gap between the event sequence identifier of each event and the event sequence identifier of a predecessor event. Thus, an event sequence identifier is assigned to each event of the plurality of events, where there is a gap between two event sequence identifiers. In certain embodiments, each event sequence identifier can be a numeric value, and the gap between two event sequence identifiers can be a gap of one. In certain embodiments, there can be a gap between more than two event sequence identifiers. An event sequencer is subsequently invoked. The flow then proceeds to 930.

At 930, the event sequencer receives the event group that includes the plurality of events. The flow then proceeds to 935.

At 935, a list of tasks that are to be executed for the event are selected. The tasks can be defined for a supply chain financial orchestration flow, where a supply chain financial orchestration flow defines a trade relationship between a first entity and a second entity. Each task can be a financial accounting task associated with an internal transaction. The event can also be defined as a task generating event for the supply chain financial orchestration flow. The flow then proceeds to 940.

At 940, a task group is created that includes the selected tasks. A task sequence identifier is assigned to each task of the task group, where there is a gap between two task sequence identifiers. In certain embodiments, each task sequence identifier can be a numeric value, and the gap between two task sequence identifiers can be a gap of one. In certain embodiments, there can be a gap between more than two task sequence identifiers. A task sequencer is subsequently invoked. A task sequencer can be a mediator resequencer, where a mediator resequencer is a system component that can rearrange a stream of related but out-of-sequence messages into a sequential order. The flow then proceeds to 945.

At 945, the task sequencer receives the task group that includes the selected tasks. The flow then proceeds to 950.

At 950, the task sequencer initiates an execution of a task of the selected tasks if the task is eligible for execution. The flow then proceeds to 955.

At 955, the task is executed. In certain embodiments, an external target system can execute the task. The flow then proceeds to 960.

At 960, a task status is updated. In certain embodiments, a callback service updates the task status. Also in certain embodiments, the task status is updated to a status that indicates the task has completed execution. The flow then proceeds to 965.

At 965, it is determined whether all the selected tasks for the event have completed their execution. If it is determined that all the selected tasks for the event have completed their execution and it is further determined that there are no remaining events of the plurality of events to process, the flow ends. However, if it is determined that all the selected tasks for the event have completed their execution, and it is further determined that there is at least one remaining event of the plurality of events to process, an event completion acknowledgement is submitted to the event sequencer, where the event completion acknowledgment makes a plurality of tasks for a subsequent event of the plurality of events eligible for execution, and the flow returns to 930. If it is determined that all the selected tasks for the event have not completed their execution, then the flow proceeds to 970.

At 970, a task completion acknowledgement is submitted to the task sequencer, where the task completion acknowledgment makes a subsequent task of the selected tasks eligible for execution, and then the flow returns to 945. Subsequently, an execution of a subsequent task is initiated, and even further, an execution of each task of the selected tasks is ultimately initiated.

In one embodiment, a supply chain financial orchestration system can handle a repetition of events. A repetition of events means that there are multiple child events possible for a given parent event. For example, there can be multiple CON events that refer to a single RCV event, or there can be multiple RCV events for a given ASN event. It can be difficult to handle the events when they arrive in repetition without a mechanism of queuing the events in a pre-defined order of their occurrence hierarchy. An event sequencer (i.e., mediator resequencer) can help in achieving this via multiple groups, where the group name and the sequence in the group handles the processing of the events in the order queued in it.

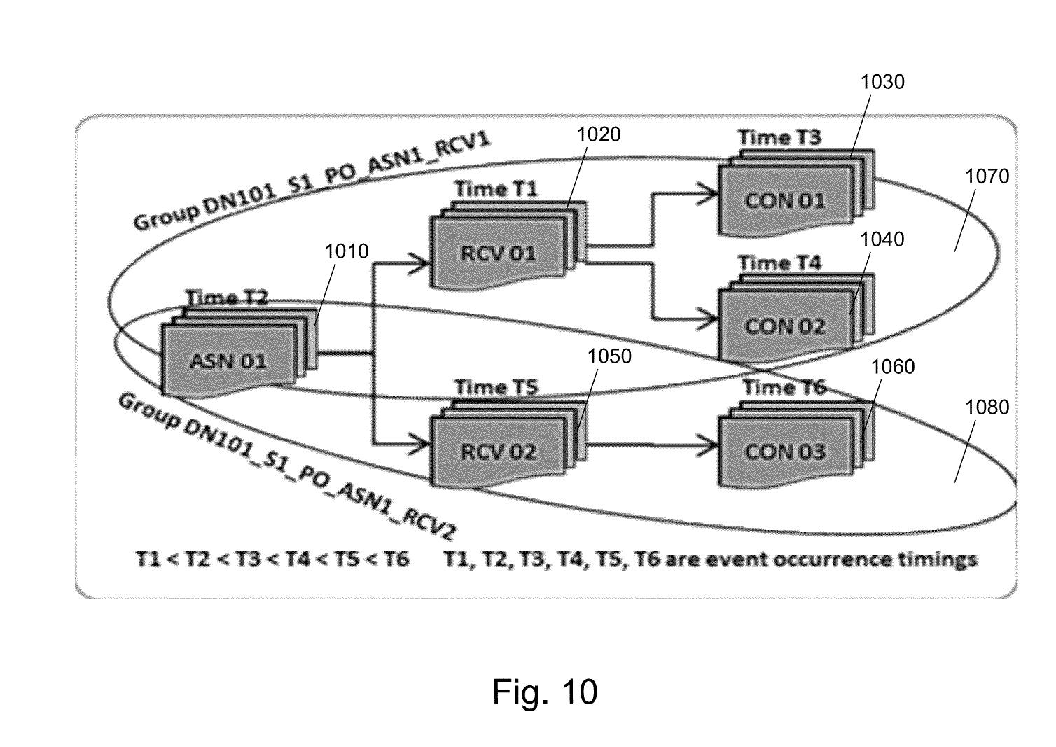

FIG. 10 illustrates a block diagram of a repetitive event occurrence hierarchy and the events' occurrence timings, according to an embodiment of the invention. According to the embodiment, an event hierarchy can be defined by a user, where an expected order of execution of events is as follows: first, an ASN event, and its related tasks, are executed; second, an RCV event, and its related tasks, are executed; and third, a CON event, and its related tasks, are executed. Thus, an ASN event is a parent event of an RCV event, the RCV event is the child event of the ASN event, the RCV event is a parent event of a CON event, and the CON event is a child event of the RCV event.

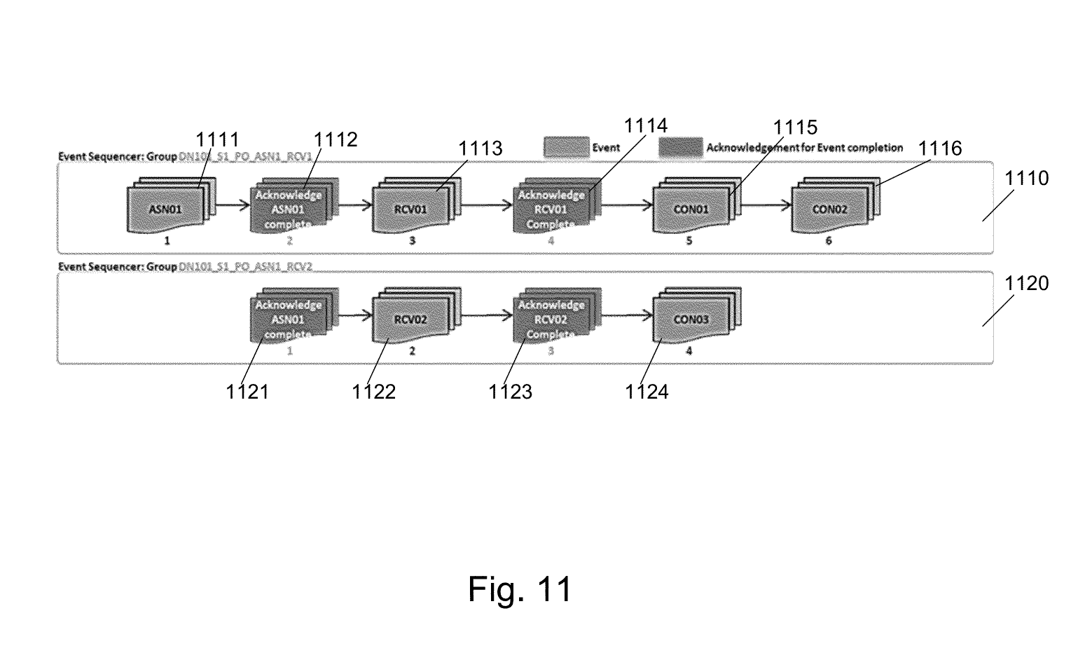

According to an embodiment, a supply chain financial orchestration system can receive the events in an order that is different from the order defined by the event hierarchy. For example, as illustrated in FIG. 10, the supply chain orchestration system may receive event 1020 (i.e., event RCV1) at time T1, may receive event 1010 (i.e., event ASN1) at time T2, may receive event 1030 (i.e., event CON1) at time T3, may receive event 1040 (i.e., event CON02) at time T4, may receive event 1050 (i.e., event RCV02) at time T5, and may receive event 1060 (i.e., event CON03) at time T6. Because event 1020 is not eligible for execution at time T1 (due to the fact that event 1010, event 1020's parent event, has not yet been received by the supply chain financial orchestration system), event 1020 is parked. When event 1010 is received, all the events that were previously parked are picked up and submitted to an event group (i.e., event group 1070) and are each assigned an event sequence identifier. When events 1030 and 1040 are received, these events are pushed to event group 1070, and also assigned event sequence identifiers. When event 1050 is received, a new event group (event group 1080) is created. Events 1050 and 1060 are pushed to event group 1080, and are also assigned event sequence identifiers. This is further described in conjunction with FIG. 11.

FIG. 11 illustrates a block diagram of event groups that include events and event completion acknowledgments, according to an embodiment of the invention. More specifically, an event group 1110 is created within an event sequencer (i.e., mediator resequencer). Event group 1110 can be named using a format DocNum_SystemID_DocType_(EventType1+Occurrence)_EventType2+Occurrence)_. . . _(EventType(n−1)+Occurrence) (e.g., DN101_S1_PO_ASN1_RCV1). As previously described in conjunction with FIG. 10, a supply chain financial orchestration system can receive event 1113 (i.e., event RCV1) at time T1, can receive event 1111 (i.e., event ASN01) at time T2, can receive event 1115 (i.e., event CON01) at time T3, can receive event 1116 (i.e., event CON02) at time T4, can receive event 1122 (i.e., event RCV02) at time T5, and can receive event 1124 (i.e., event CON03) at time T6. Because event 1113 is not eligible for execution at time T1 (due to the fact that event 1111, event 1113's parent event, has not yet been received by the supply chain financial orchestration system, event 1113 is parked. When event 1111 is received by the supply chain financial orchestration system, events 1111 and 1113 are pushed to event group 1110, and event sequence identifiers of 1 and 3 are assigned to events 1111 and 1113, respectively.

According to the embodiment, an event sequence identifier can be calculated based on a completion status of the previous event (i.e., the parent event type). If the previous event has completed execution before the reception of the current event, then the event sequence identifier for the current identifier can be assigned as the previous event's event sequence identifier+1. If the previous event has not completed execution before the reception of the current event, then the event sequence identifier for the current event can be assigned as the previous event's event sequence identifier+2.

When events 1115 and 1116 are received by the supply chain financial orchestration system (in that order), then events 1115 and 1116 are pushed to event group 1110 with the event sequence identifiers of 4 and 5, or 5 and 6, based on the completion of the execution of the tasks related to event 1113. That is, event sequence identifiers of 4 and 5 are assigned to events 1115 and 1116 when all the tasks related to event 1113 have completed execution. Event sequence identifiers of 5 and 6 are assigned to events 1115 and 1116 when all the tasks related to event 1113 have not completed execution. According to the embodiment, events 1115 and 1116 can be assigned sequential event sequence identifiers since they are not dependent on each other (i.e., they can be executed in parallel).

When event 1122 is received, a new event group (i.e., event group 1120) is created because event 1122 is a new child event occurrence of event 1111, and all child events of event 1122 are queued within event group 1120. An event sequence identifier of event 1122 is set to either 1 or 2 based on the completion of the execution of the tasks related to event 1111. Further, when event 1124 is received, event 1124 is pushed to event group 1120, and assigned an event sequence identifier of either 2, 3, or 4, based on the completion of the execution of the tasks related to event 1111 and the completion of the execution of the tasks related to event 1122. This is illustrated in the following table:

| | Parent | | Event Sequence |
|---|---|---|---|
| Event | Event | Group Name | Identifier |
| ASN01 | | DN101_S1_PO_ASN1_RCV1 | 1 |
| RCV01 | ASN01 | DN101_S1_PO_ASN1_RCV1 | 3 |
| CON01 | RCV01 | DN101_S1_PO_ASN1_RCV1 | 4 or 5 |
| CON02 | RCV01 | DN101_S1_PO_ASN1_RCV1 | 5 or 6 |
| RCV02 | ASN01 | DN101_S1_PO_ASN1_RCV2 | 1 or 2 |
| CON03 | RCV02 | DN101_S1_PO_ASN1_RCV2 | 2 or 3 |
| | | | OR |
| | | | 3 or 4 |

When all of the tasks related to an event have completed their execution, an event completion acknowledgment is sent to the event sequencer so that the tasks related to the next event can be submitted to a task sequencer for execution. In the illustrated embodiment, when all the tasks related to event 1111 have completed their execution, an event completion acknowledgement 1112 (i.e., ASN event completion acknowledgment) is submitted to the event sequencer, which pushes all the tasks related to event 1113 to the task sequencer for execution. Further, an event completion acknowledgement 1121 (i.e., ASN event completion acknowledgment) is also submitted to the event sequencer, which pushes all the tasks related to event 1122 to the task sequencer for execution. Similarly, when all the tasks related to event 1113 have completed their execution, an event completion acknowledgment 1114 (i.e., RCV event completion acknowledgement) is submitted to the event sequencer, which pushes all the tasks related to event 1115 and related to event 1116 (as both events can run in parallel) to the task sequencer for execution. Likewise, when all the tasks related to event 1122 have completed their execution, an event completion acknowledgment 1123 (i.e., RCV event completion acknowledgment) is submitted to the event sequencer, which pushes all the tasks related to event 1124 to the task sequencer for execution.

FIG. 12 illustrates a flow diagram of the repetitive event sequencer functionality of a supply chain financial orchestration sequencer module, according to another embodiment of the invention. The flow begins and proceeds to 1210. At 1210, an event is received. In certain embodiments, the event can be an event of a plurality of events. The flow then proceeds to 1215.

At 1215, it is determined whether the event is a first event in an event hierarchy or whether a parent event of the event has been processed. The event hierarchy can define an order of execution of the plurality of events. A predecessor event can be a parent event of a successor event within the event hierarchy. Further, the successor event can be a child event of the predecessor event within the event hierarchy. If it is determined that the event is not a first event in the event hierarchy, and that the parent event of the event has not been processed, the flow proceeds to 1220. If it is determined that the event is a first event in the event hierarchy, or that the parent event of the event has been processed, the flow proceeds to 1225.

At 1220, the event is parked for future processing. An event sequencer can be a mediator resequencer, where a mediator resequencer is a system component that can rearrange a stream of related but out-of-sequence messages into a sequential order. The flow then ends.

At 1225, if the event is a topmost event of an event hierarchy (i.e., if the event is the first event received of the event hierarchy), or if the event is a child event of the topmost event, then an event group is created that includes the plurality of events. An event sequence identifier is assigned to the event. If any event is parked and waiting on the current event, then an event sequence identifier is assigned to the parked events that includes a gap between the event sequence identifier of the event and the event sequence identifier of a predecessor event. Thus, an event sequence identifier is assigned to each event of the plurality of events, where there is a gap between two event sequence identifiers. In certain embodiments, each event sequence identifier can be a numeric value, and the gap between two event sequence identifiers can be a gap of one. In certain embodiments, there can be a gap between more than two event sequence identifiers. An event sequencer is subsequently invoked. The flow then proceeds to 1230.

At 1230, the event sequencer receives the event group that includes the plurality of events. The flow then proceeds to 1235.

At 1235, a list of tasks that are to be executed for the event are selected. The tasks can be defined for a supply chain financial orchestration flow, where a supply chain financial orchestration flow defines a trade relationship between a first entity and a second entity. Each task can be a financial accounting task associated with an internal transaction. The event can also be defined as a task generating event for the supply chain financial orchestration flow. The flow then proceeds to 1240.

At 1240, a task group is created that includes the selected tasks. A task sequence identifier is assigned to each task of the task group, where there is a gap between two task sequence identifiers. In certain embodiments, each task sequence identifier can be a numeric value, and the gap between two task sequence identifiers can be a gap of one. In certain embodiments, there can be a gap between more than two task sequence identifiers. A task sequencer is subsequently invoked. A task sequencer can be a mediator resequencer, where a mediator resequencer is a system component that can rearrange a stream of related but out-of-sequence messages into a sequential order. The flow then proceeds to 1245.

At 1245, the task sequencer receives the task group that includes the selected tasks. The flow then proceeds to 1250.

At 1250, the task sequencer initiates an execution of a task of the selected tasks if the task is eligible for execution. The flow then proceeds to 1255.

At 1255, the task is executed. In certain embodiments, an external target system can execute the task. The flow then proceeds to 1260.

At 1260, a task status is updated. In certain embodiments, a callback service updates the task status. Also in certain embodiments, the task status is updated to a status that indicates the task has completed execution. The flow then proceeds to 1265.

At 1265, it is determined whether all the selected tasks for the event have completed their execution. If it is determined that all the selected tasks for the event have completed their execution and it is further determined that there are no remaining events of the plurality of events to process, the flow ends. However, if it is determined that all the selected tasks for the event have completed their execution, and it is further determined that there is at least one remaining event of the plurality of events to process, an event completion acknowledgement is submitted to the event sequencer, where the event completion acknowledgment makes a plurality of tasks for a subsequent event of the plurality of events eligible for execution, and the flow returns to 1230. If it is determined that all the selected tasks for the event have not completed their execution, then the flow proceeds to 1270.

At 1270, a task completion acknowledgement is submitted to the task sequencer, where the task completion acknowledgment makes a subsequent task of the selected tasks eligible for execution, and then the flow returns to 1245. Subsequently, an execution of a subsequent task is initiated, and even further, an execution of each task of the selected tasks is ultimately initiated.

Thus, in one embodiment, a supply chain financial orchestration system can receive an event and initiate execution of one or more tasks, when a successor task is not initiated until a predecessor task has completed its execution. The supply chain financial orchestration system can further sequence a plurality of received events, where tasks for a successor event are not initiated until all tasks of a predecessor event have completed their execution. Further, the supply chain financial orchestration system can queue multiple child events for a given parent event so that the event are processed in a prescribed order of their occurrence hierarchy. This allows the supply chain financial orchestration system to maintain a sequence defined by a trade relationship. Such a sequence can allow for more precise orchestration of supply chain financial orchestration tasks associated with an internal transaction.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to orchestrate tasks for a supply chain financial orchestration flow, the orchestrating comprising:
selecting a plurality of tasks to be executed for an event, wherein each task comprises a financial accounting task associated with an internal transaction;
creating a task group that comprises the plurality of tasks;
assigning a task sequence identifier for each task of the plurality of tasks; wherein there is a gap between at least two task sequence identifiers;
initiating an execution of a task of the plurality of tasks where the task is eligible for execution; and
submitting a task completion acknowledgement when the execution of the task is complete, wherein the task completion acknowledgement makes a subsequent task eligible for execution.

2. The computer-readable medium of claim 1, the orchestrating further comprising:
receiving a plurality of events that comprises the event;
creating an event group that comprises the plurality of events;
assigning an event sequence identifier for each event of the plurality of events, wherein there is a gap between at least two event sequence identifiers; and
submitting an event completion acknowledgement when the execution of the plurality of tasks for the event is complete, wherein the event completion acknowledgement makes a plurality of tasks for a subsequent event eligible for execution.

3. The computer-readable medium of claim 2, the orchestrating further comprising:
for each received event, determining whether the received event requires a creation of a separate event group; and
for each received event that is determined to require the creation of a separate event group, creating a separate event group that comprises the received event.

4. The computer-readable medium of claim 3, the orchestrating further comprising:
for each received event, determining which event group the event belongs to; and
for each received event, pushing the received event into the determined event group.

5. The computer-readable medium of claim 4, the determining whether the received event requires a creation of a separate event group further comprising:
determining whether the received event is: (a) a first event in an event hierarchy; or (b) a child event of the first event in an event hierarchy where another child event of the first event has previously been received;
wherein the event hierarchy comprises an order of execution of the plurality events; and
wherein a predecessor event is a parent event of a successor event within the event hierarchy; wherein the successor event is a child event of the predecessor event within the hierarchy.

6. The computer-readable medium of claim 1, the orchestrating further comprising executing the task.

7. The computer-readable medium of claim 6, the orchestrating further comprising updating a status of the task.

8. The computer-readable medium of claim 7, the orchestrating further comprising initiating an execution of the subsequent task when the subsequent task is eligible for execution.

9. The computer-readable medium of claim 8, the orchestrating further comprising initiating an execution of each task of the plurality of tasks when each task is eligible for execution.

10. The computer-readable medium of claim 1,
wherein the plurality of tasks are defined for the supply chain financial orchestration flow; and
wherein the event is defined as a task generating event for the supply chain financial orchestration flow.

11. A computer-implemented method for orchestrating tasks for a supply chain financial orchestration flow, the computer-implemented method comprising:
selecting a plurality of tasks to be executed for an event; wherein each task comprises a financial accounting task associated with an internal transaction creating a task group that comprises the plurality of tasks;
assigning a task sequence identifier for each task of the plurality of tasks; wherein there is a gap between at least two task sequence identifiers;
initiating an execution of a task of the plurality of tasks where the task is eligible for execution; and
submitting a task completion acknowledgement when the execution of the task is complete, wherein the task completion acknowledgement makes a subsequent task eligible for execution.

12. The computer-implemented method of claim 11, further comprising:
receiving a plurality of events that comprises the event;
creating an event group that comprises the plurality of events;
assigning an event sequence identifier for each event of the plurality of events, wherein there is a gap between at least two event sequence identifiers; and
submitting an event completion acknowledgement when the execution of the plurality of tasks for the event is complete, wherein the event completion acknowledgement makes a plurality of tasks for a subsequent event eligible for execution.

13. The computer-implemented method of claim 12, further comprising:
for each received event, determining whether the received event requires a creation of a separate event group; and
for each received event that is determined to require the creation of a separate event group, creating a separate event group that comprises the received event.

14. The computer-implemented method of claim 13, further comprising:
for each received event, determining which event group the event belongs to; and
for each received event, pushing the received event into the determined event group.

15. The computer-implemented method of claim 14, the determining whether the received event requires a creation of a separate event group further comprising:
determining whether the received event is: (a) a first event in an event hierarchy; or (b) a child event of the first event in an event hierarchy where another child event of the first event has previously been received;
wherein the event hierarchy comprises an order of execution of the plurality events; and
wherein a predecessor event is a parent event of a successor event within the event hierarchy; wherein the successor event is a child event of the predecessor event within the hierarchy.

16. A system, comprising:
a task selection module configured to select a plurality of tasks to be executed for an event, wherein each task comprises a financial accounting task associated with an internal transaction;
a task group creation module configured to create a task group that comprises the plurality of tasks;
a task sequence identifier assignment module configured to assign a task sequence identifier for each task of the plurality of tasks; wherein there is a gap between at least two task sequence identifiers;
a task execution initiation module configured to initiate an execution of a task of the plurality of tasks where the task is eligible for execution; and
a task completion acknowledgment submission module configured to submit a task completion acknowledgement when the execution of the task is complete, wherein the task completion acknowledgement makes a subsequent task eligible for execution.

17. The system of claim 16, further comprising:
an event reception module configured to receive a plurality of events that comprises the event;
an event group creation module configured to create an event group that comprises the plurality of events;
an event sequence identifier assignment module configured to assign an event sequence identifier for each event of the plurality of events, wherein there is a gap between at least two event sequence identifiers; and
an event completion acknowledgment submission module configured to submit an event completion acknowledgement when the execution of the plurality of tasks for the event is complete, wherein the event completion acknowledgement makes a plurality of tasks for a subsequent event eligible for execution.

18. The system of claim 17:
wherein the event reception module is further configured, for each received event, to determine whether the received event requires a creation of a separate event group; and
wherein the event group creation module is further configured, for each received event that is determined to require the creation of a separate event group, to create a separate event group that comprises the received event.

19. The system of claim 18:
wherein the event reception module is further configured, for each received event, to determine which event group the event belongs to; and
wherein the event group creation module is further configured, for each received event, to push the received event into the determined event group.

20. The system of claim 19:
wherein the event reception module is further configured to determine whether the received event is: (a) a first event in an event hierarchy; or (b) a child event of the first event in an event hierarchy where another child event of the first event has previously been received;
wherein the event hierarchy comprises an order of execution of the plurality events; and
wherein a predecessor event is a parent event of a successor event within the event hierarchy; wherein the successor event is a child event of the predecessor event within the hierarchy.
